(19) United States
(12) Patent Application Publication
(10) Pub. No.: US 2004/0018316 A1
(43) Pub. Date: Jan. 29, 2004

(54) Production method for aluminum alloy coated steel sheet

(75) Inventors: Janghyun Choi, Pusan (KR); Byeongmoon Lim, Pusan (KR); Jeonghee Choi, Pusan (KR); Seonjin Chin, Pusan (KR); Jaein Jeong, Pusan (KR)

Correspondence Address: THOMAS P O'CONNELL, 135 CAMBRIDGE STREET SUITE 10, BURLINGTON, MA, 01803

(73) Assignee: Unionsteel Manufacturing Co., Ltd.,, Pusan (KR)

(21) Appl. No.: 10/206,226

(22) Filed: Jul. 29, 2002

(51) Int. Cl. B05D 1/18

(52) U.S. Cl. 427/431

(57) ABSTRACT

A production method for an aluminum alloy coated steel sheet. The aluminum alloy coated steel sheet is improved in appearance, corrosion resistance and workability resulting from dipping a base steel sheet into an aluminum alloy coating bath with a Si content of 5 to 15 parts by weight, a Cr content of 0.1 to 1.5 parts by weight and a Mg content of 0.01 to 3.0 parts by weight. Because of excellent workability, peeling of a coating layer and cracks of a coating film are reduced upon press working, thereby corrosion resistance being improved even after working. As a result, car mufflers, heat resistant home electric appliances, etc. having improved corrosion resistance can be produced.

### BACKGROUND OF THE INVENTION

1. Field of the Invention

The present invention relates to a production method for an aluminum alloy coated steel sheet with excellent corrosion resistance and workability.

2. Description of the Related Art

Aluminum coated steel sheets have mainly been used in car mufflers, home electric appliances, heat resistant materials, and the like due to their corrosion resistance and heat resistance, superior to zinc coated steel sheets.

By way of example, refer to an aluminum coated steel sheet consisting of Fe, Ti, etc. (Japanese Patent Laid-Open Publication No. Sho. 57-47861), an aluminum coated steel sheet consisting of Fe, C, Si, Cu, Ni, and small amount of Cr (Japanese Patent Laid-Open Publication No. Sho. 63-184043), and an aluminum alloy coated steel sheet comprising a coating layer consisting of a Mn content of 0.01 to 4.0% by weight, a Ti content of 0.001 to 1.5% by weight, a Si content of 3.0 to 15.0% by weight and the balance Al (Japanese Patent Laid-Open Publication No. Sho. 60-243258).

Generally, an aluminum coated steel sheet is produced by heating a cold-rolled steel sheet under non-oxidative atmosphere or weak oxidative atmosphere to thereby remove contaminants including oil and grease on the surface of the steel sheet, heating the steel sheet using an annealing process under a reductive atmosphere to thereby activate the surface of the steel sheet, and dipping the steel sheet into a molten aluminum bath.

With respect to an aluminum coated steel sheet produced in this way, reaction of Al with Fe in the base steel sheet results in the formation of a Fe—Al alloy layer, or rapid infiltration of Al into Fe through diffusion. In order to control these phenomena, generally, a Si content of 10% or less has been added to an aluminum coating bath. The aluminum coated steel sheet thus produced is relatively excellent in workability and heat resistance and thus has been mainly used in a car muffler, a hot water supply device, a heating device, an electric rice cooker and the like.

In some cases, however, silicon, which is added to control the formation of an alloy layer, degrades the appearance of the coated steel sheet, thereby making the appearance of the steel sheet unclear.

Recently, to prolong the service life of parts of automobile exhaust systems, in particular, an aluminum coated steel sheet comprising Cr has been developed. By way of example, refer to an aluminum coated steel sheet comprising a Cr content of 1.8 to 3.0% by weight (Japanese Patent Laid-Open Publication No. Sho. 63-18043) and an aluminum coated steel sheet comprising a Cr content of 2 to 3% by weight (Japanese Patent Laid-Open Publication No. Sho. 63-47456).

The present invention concerns an improvement in a conventional production method for an aluminum coated steel sheet comprising a Si-containing coating layer. The present invention presents a production method for an aluminum alloy coated steel sheet still more improved in workability, corrosion resistance and heat resistance, resulting from adding Cr and Mg to a Si-containing coating bath and thereby suppressing the growth of an alloy layer adversely affecting the workability and appearance of the coated steel sheet.

### SUMMARY OF THE INVENTION

Therefore, the present invention has been made in view of the above problems, and it is an object of the present invention to provide a production method for an aluminum alloy coated steel sheet with excellent workability and corrosion resistance, resulting from adding Cr and Mg to a coating bath, wherein the Cr and Mg readily form an alloy with Al and serve to improve the appearance, corrosion resistance and heat resistance of the steel sheet.

In accordance with the present invention, the above object and other objects can be accomplished by the provision of a production method for an aluminum alloy coated steel sheet, comprising dipping a base steel sheet into a coating bath of an Al—Si—Cr—Mg bath composition with a Si content of 5 to 15 parts by weight, a Cr content of 0.1 to 1.5 parts by weight and a Mg content of 0.01 to 3.0 parts by weight.

### DESCRIPTION OF THE PREFERRED EMBODIMENTS

Hereinafter, the present invention will be described in more detail.

5 to 15 parts by weight of Si is contained in the coating bath according to the present invention. Si is an element which suppresses the growth of an alloy layer and improves the flowability of the coating bath, thereby to impart gloss to the surface of a coated steel sheet. For these purposes, Si must be added in an amount of at least 5 parts by weight. On the other hand, if the content of Si exceeds 15 parts by weight, silicon phases in the form of sheets are precipitated on a coating layer, thereby greatly reducing the workability of the coating layer. Therefore, it is preferable to limit the Si content to a range of 5 to 15 parts by weight.

Cr serves to form a close passive oxide film on the surface of a coating layer and thereby improves the corrosion resistance of a coated steel sheet, simultaneously with reducing the grain size of an alloy layer due to uniform distribution of Cr in a coating bath.

In addition, Cr is accumulated in a band form in a coating layer, and thus improves workability and corrosion resistance in fracture surfaces after working.

If the Cr content is less than 0.1 parts by weight, the effect achieved by its uniform distribution in a coating bath is not satisfactory, while if it exceeds 1.5 parts by weight, it is necessary to raise the temperature of the coating bath relative to the increase of the Cr content. As the temperature of the coating bath increases, the amount of dross increases, thereby the appearance of the coated steel sheet being damaged due to the attachment of the dross to the surface of the steel sheet. Therefore, it is preferable to limit the Cr content to a range of 0.1 to 1.5 parts by weight.

Mg reacts with atmospheric oxygen being in contact with a coating layer to form a passive film, thereby interrupting diffusion of oxygen into an alloy layer and thus preventing further progression of corrosion, and improves heat resistance.

Furthermore, Mg reacts with Al to interrupt diffusion of oxygen, thereby remarkably improving corrosion resistance of shear surfaces after working.

If the Mg content is less than 0.01 parts by weight, the effect achieved by its uniform distribution in a coating bath is not satisfactory, while if it exceeds 3.0 parts by weight, efficiency of work is reduced and the amount of dross is increased due to the raised melting temperature, simultaneously with a coating bath being saturated. Therefore, it is preferable to limit the Mg content to a range of 0.01 to 3.0 parts by weight.

The present invention is based on the discovery that where Cr and Mg are simultaneously added to a conventional Al-containing coating bath with a Si content of 5 to 15 parts by weight, the chance of nucleation occurring is increased and thus the size of spangle is reduced.

That is, after a steel sheet is dipped into a molten Al alloy coating bath, the added components are dispersed in a coating layer to create numerous nuclei. Therefore, in the course of coating materials being solidified, mutual interference between grain boundaries controls the growth of grains.

Accordingly, a beautiful appearance of the coated steel sheet is secured, and corrosion resistance is improved due to the suppression of intergranular corrosion. Furthermore, growth of an Al—Fe alloy layer is suppressed, thereby a coating layer with excellent workability being formed.

Meanwhile, it is preferable to set the temperature of a base steel sheet when bathing the steel sheet in a molten coating bath to 650 to 700° C., and the temperature of the molten coating bath to 620 to 680° C.

If the bathing temperature of the base steel sheet is less than 650° C., the appearance of the coating film is poor and coating adhesion to the steel sheet is lowered. On the other hand, if it exceeds 700° C., the thermal diffusion of the base steel sheet is faster and thus an alloy layer grows abnormally. As a result, workability is lowered and oxides are excessively formed in the molten coating bath.

An adhesion quantity of coating is preferably 20 to 300 g/m², on a one surface basis. If the adhesion quantity of coating is less than 20 g/m², the air pressure of an air knife adjusting the adhesion quantity of coating is excessively increased and thus the variation in the adhesion quantity of coating occurs. At the same time, oxides are rapidly increased in a molten coating bath, thereby the appearance of the coating film being damaged and oxide dross being attached to the coating film.

Furthermore, if the adhesion quantity of coating exceeds 300 g/m², an alloy layer grows excessively, thereby workability being remarkably reduced.

### EXAMPLES

The invention will be described with reference to, but is not limited to, the following examples.

Each cold-rolled steel sheet with thickness of 0.8 mm and width of 30 mm, was dipped into non-oxidative furnace type pilot plant for molten coating while varying the composition of a coating bath as shown in Table 1 to prepare an Al alloy coated steel sheet.

The adhesion quantity of coating was adjusted using an air knife. The properties of the produced Al alloy coated steel sheets were evaluated and the results are presented in Table 1.

Evaluation items were corrosion resistance and workability. The corrosion resistance was evaluated as the time that elapses before visible red rusts (5%) occur under a 5% NaCl spray test at 35° C. according to KSD 9504 method. The workability was evaluated as the crack width (fracture width) measured after examining the fracture surface using a stereo microscope at 30 to 50 magnifications following 180°OT bending test according to KSD 0006 method.

TABLE 1

| | | | | Adhesion | | | |
|---|---|---|---|---|---|---|---|
| | | | | quantity | | Corrosion | |
| | | | | of | | resistance | |
| | | | | coating | | (brine spray | |
| | Composition of coating | | | (one | | test) | |
| | bath (parts by weight) | | | surface | Workability | Flat | Shear |
| | Silicon | Chromium | Magnesium | basis) | (fracture | portion | portion |
| Section | (Si) | (Cr) | (Mg) | (g/m²) | width) (μm) | (hrs) | (hrs) |
| Inv.1 | 5.0 | 0.1 | 0.01 | 40 | 10-15 | 1050 | 950 |
| Inv.2 | 10.0 | 0.3 | 0.01 | | | 3500 | 1200 |
| Inv.3 | 12.0 | 0.5 | 0.01 | | | 4500 | 1500 |
| Inv.4 | 5.0 | 1.0 | 0.5 | | | 2700 | 850 |
| Inv.5 | 12.0 | 1.5 | 0.01 | | | 3000 | 1100 |
| Inv.6 | 5.0 | 1.5 | 0.1 | | | 3200 | 1000 |
| Inv.7 | 10.0 | 1.2 | 1.0 | | | 2800 | 900 |
| Inv.8 | 15.0 | 0.7 | 0.1 | | | 3400 | 1000 |
| Inv.9 | 10.0 | 0.9 | 2.0 | | | 3800 | 1200 |
| Inv.10 | 12.0 | 0.5 | 3.0 | | | 3300 | 800 |
| Inv.11 | 5.0 | 1.0 | 1.0 | | | 2500 | 650 |
| Comp.12 | 5.0 | 0.05 | 0.005 | | 15-20 | 850 | 300 |
| Comp.13 | 10.0 | 0.01 | 0.007 | | | 1300 | 450 |
| Comp.14 | 12.0 | 0.001 | 0.003 | | | 1250 | 480 |
| Comp.15 | 10.0 | — | — | 45 | 30-45 | 1200 | 450 |

As shown in Table 1, the examples according to the present invention were excellent in workability and corrosion resistance. That is, in case of the inventive examples, the crack (fracture) width was 10 to 15 μm, which is superior to the comparative examples, after 180°OT bending test. With reference to corrosion resistance, in case of the inventive examples, 5% red rusts on flat portions were visualized after about 3,000 hours and 5% red rusts on shear portions were visualized after about 1,000 hours, superior to times of about 1,200 and 450 hours in the comparative examples.

According to visual evaluation, the inventive examples were good in the appearance of the coated steel sheet, compared with the comparative examples. This is attributed to the reduction of the size of spangle.

As apparent from the above description, the present invention provides a production method for an aluminum alloy coated steel sheet, in which the appearance, corrosion resistance and workability are improved due to the reduction of size of grains depending on mutual interference between grain boundaries, resulting from adding small amounts of Cr and Mg to a conventional aluminum coating bath with a Si content of 5 to 15 parts by weight.

In addition, because of excellent workability, peeling of a coating layer and cracks of a coating film are reduced upon press working, thereby corrosion resistance being improved even after working. As a result, car mufflers, heat resistant home electric appliances, etc. having improved corrosion resistance can be produced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A production method for an aluminum alloy coated steel sheet, comprising dipping a base steel sheet into a coating bath of an Al—Si—Cr—Mg bath composition with a Si content of 5 to 15 parts by weight, a Cr content of 0.1 to 1.5 parts by weight and a Mg content of 0.01 to 3.0 parts by weight.

2. The production method as set forth in claim 1, wherein an adhesion quantity of coating is 20 to 300 g/m² on a one surface basis.

3. The production method as set forth in claim 1 or claim 2, wherein the bathing temperature of the base steel sheet is 650 to 700° C.
